(19) United States
(12) Patent Application Publication
(10) Pub. No.: US 2005/0256770 A1
(43) Pub. Date: Nov. 17, 2005

(54) Method and apparatus for distributing a digital media product with an adaptable purchase incentive

(76) Inventors: Laird Popkin, New York, NY (US); Howard Singer, Morganville, NJ (US)

Correspondence Address: INTELLECTUAL PROPERTY DEVELOPMENT / JACK J' MAEV, 187 W.ORANGETHORPE AVE., SUITE H, PLACENTIA, CA, 92870, US

(21) Appl. No.: 10/845,599

(22) Filed: May 12, 2004

(51) Int. Cl. G06F 17/60

(52) U.S. Cl. 705/14

(57) ABSTRACT

A method and apparatus for providing content by providing a first digital media product. An incentive is determined according to a preference exhibited by a consumer. The determined incentive is provided when the consumer satisfies an incentive threshold.

### BACKGROUND

Content providers are continually adapting to the winds of change brought about by digital distribution. Today, there are numerous means for selling content. In the realm of digital distribution of audio entertainment, the music industry has attempted to adapt marketing principals of normally associated with a simpler age. One principal that the early music industry used to promote the sale of audio content was that of increasing perceived value. For example, the music industry quickly developed the notion of marketing music in a bundle, e.g. an album. By selling an album, the music industry could promote one or two popular songs included on the album. Concurrently, the perceived value of an album purchase helped to raise revenues. It is, though, worthwhile to note that many of the songs on an album are typically considered superfluous by the consuming public.

None the less, digital content is typically bundled together into an album, analogous to the traditional distribution scheme used by the music industry for years. Because digital distribution of audio content is becoming so prolific, the music industry has found itself catering to demand profiles not previously known, or, for that matter, understood. One major factor that has caused the music industry to become more accommodating to new demand profiles is the prolific reach of piracy. Given the premise that most people are not inclined to convert copyrighted material to their own benefit, music companies are not inclined to capitulate to the rising tide of piracy. As such, the music industry is attempting to identify new marketing schemes that collectively raise perceived value on the part of a consumer and increase revenue.

In the arena of bootlegged music, there is little need to aggregate music or other content into bundles. Because bootlegged music carries no cost to the consumer, there is little need to improve a perceived value by bootlegging an entire album. In fact, it is often the case that unpopular content on an album is not even introduced into the piracy stream. As a result, consumers of bootlegged content can pick and choose single cuts according to individual preferences. Bootlegged content seems to offer the best that can be had. First—free music; second—single track distribution.

Again returning to the premise that most people are not averse to paying for music, the music industry has found itself in a quagmire. The industry as a whole needs to compete with the distribution model offered by the stream of pirated content. This means that the music industry needs to sell single tracks. The sale of single tracks, though, forces the industry to abandon any aggregation and any possibility of increasing the perceived value of a music purchase.

Similar marketing paradigms have also been adapted in the sale and distribution of video segments. For example, where there are several video segments of a common theme, a bundle of video segments are commonly sold as a lot. For example, a common theme could include an original movie plus one or two sequels. In another example, a common theme could include several movies all featuring a common film-star.

### SUMMARY

A method and apparatus for providing content by providing a first digital media product. An incentive is determined according to a preference exhibited by a consumer. The determined incentive is provided when the consumer satisfies an incentive threshold.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one illustrative method for providing a digital media product with an adaptable purchase incentive;

FIG. 2 is a flow diagram that depicts alternative example methods for determining an incentive;

FIG. 3 is a flow diagram that presents one alternative method for determining an incentive;

FIG. 4 is a flow diagram that depicts another alternative example method for determining an incentive;

FIG. 5 is a flow diagram that depicts yet another alternative illustrative method for determining an incentive;

FIG. 6 is a flow diagram that depicts yet another alternative method for determining an incentive;

FIG. 7 is a flow diagram that depicts alternative methods for providing a determined incentive;

FIG. 8 is a block diagram of one example embodied of an apparatus for providing digital media product; and

FIG. 9 is a data flow diagram that depicts the internal operation of one example embodiment of a digital media product distribution system.

### DETAILED DESCRIPTION

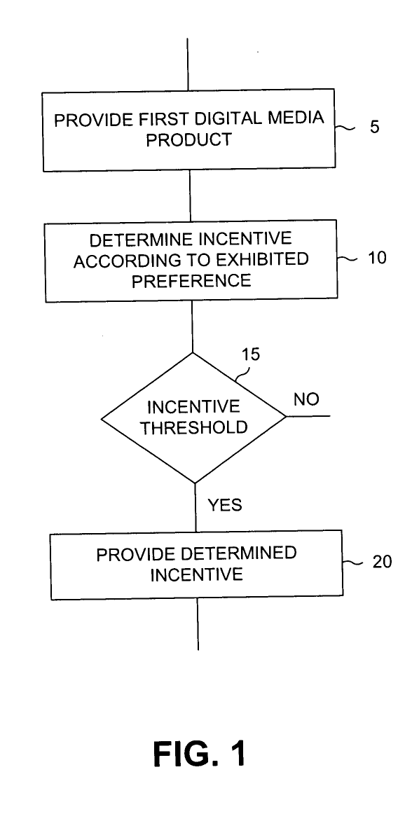

FIG. 1 is a flow diagram that depicts one illustrative method for providing a digital media product with an adaptable purchase incentive. According to this illustrative method, a first digital media product is provided to a consumer (step 5). A digital media product, according to one alternative variation of the present method, comprises at least one of a single music track and an aggregation of music tracks commonly known as an “album”. According to yet another variation of the present method, a digital media product comprises a video segment, e.g. a full-length movie. Once the first digital media product is provided to the consumer, an incentive is determined according to a preference exhibited by the consumer (step 10). When the consumer has satisfied an incentive threshold (step 15), the determined incentive is provided to the consumer (step 20).

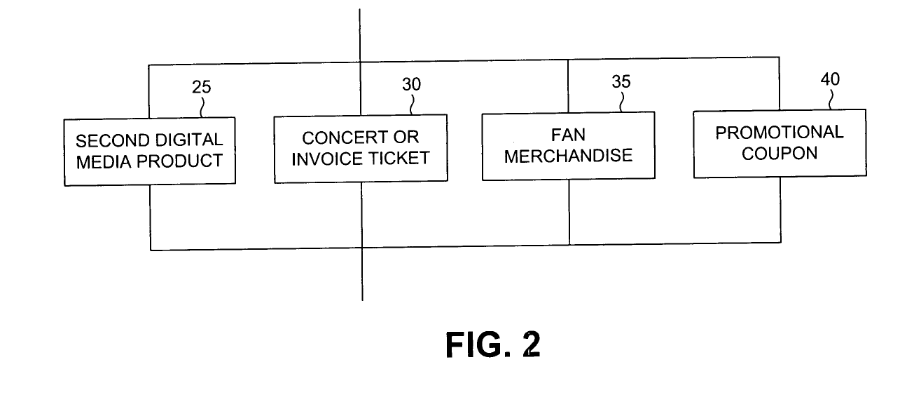

FIG. 2 is a flow diagram that depicts alternative example methods for determining an incentive. According to one alternative method, determining an incentive comprises identifying a second digital media product (step 25). A second digital media product, according to one variation of this alternative method, comprises at least one of a second music track and an album. According to yet another variation of this alternative method, a second digital media product comprises a video segment. According to another alternative method, determining an incentive comprises identification of a concert ticket (step 30) as an incentive. It should be noted that many consumers exhibiting interest in music are likely to value one or more concert tickets as an incentive for purchasing a digital media product. As another example, an avid motion picture fan may value as an incentive in movie ticket for movie featuring a film star depicted in a video segment that was purchased by the consumer as a digital media product.

In yet another alternative example method, determining an incentive comprises identification of fan merchandise (step 35) as an incentive. It should also be noted that many consumers exhibiting interest in either music or a video segment are likely to value fan merchandise as an incentive. For example, a poster depicting a recording artist may be considered invaluable incentive by a consumer of digital media products comprising music. As another example, a consumer that is interested in a particular full-length movie may be motivated to make a digital media product purchase when an incentive includes some item of paraphernalia (e.g. a model of a space ship) associated with the full-length movie. In yet another alternative example method, an incentive is determined by identifying a promotional coupon (step 40) as an incentive. A promotional coupon can included a coupon for any product or service that the provider of a first digital media product may wish to sponsor.

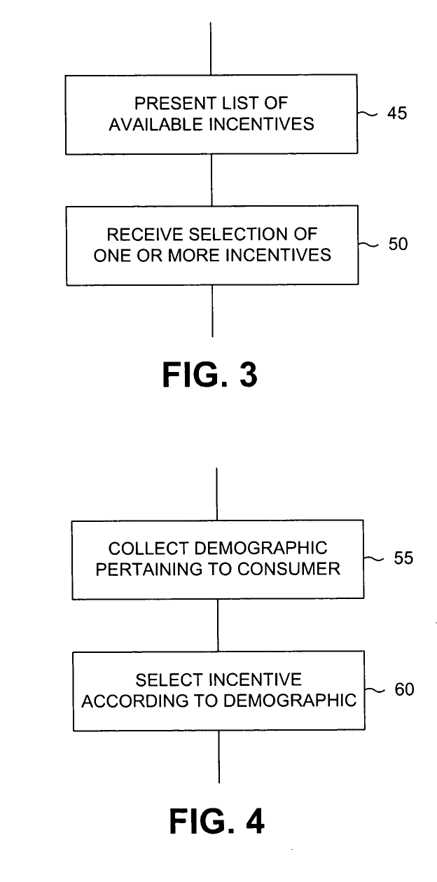

FIG. 3 is a flow diagram that presents one alternative method for determining an incentive. According to one alternative method, an incentive is determined by presenting to a consumer a list of available incentives (step 45). Given the presentation of available incentives, a selection of one or more incentives is received from the consumer (step 50).

FIG. 4 is a flow diagram that depicts another alternative example method for determining an incentive. According to this alternative example method, an incentive is determined by collecting a demographic pertaining to the consumer (step 55). According to one variation of this alternative method, a demographic includes but is not necessarily limited to at least one of a gender for the consumer, an age for the consumer, an income bracket for the consumer, marital status for the consumer, number of children for the consumer, an occupation indicator for the consumer, a favorite recording artist, a favorite film-star and a favorite pastime. An incentive is then determined according to the collected demographic (step 60). This, according to one illustrative variation of the present method, is accomplished using a weighted selection factor for a particular incentive that correlates with a collected demographic. It should be noted that the use of a weighted selection factor is a common technique for supporting demographic based selection.

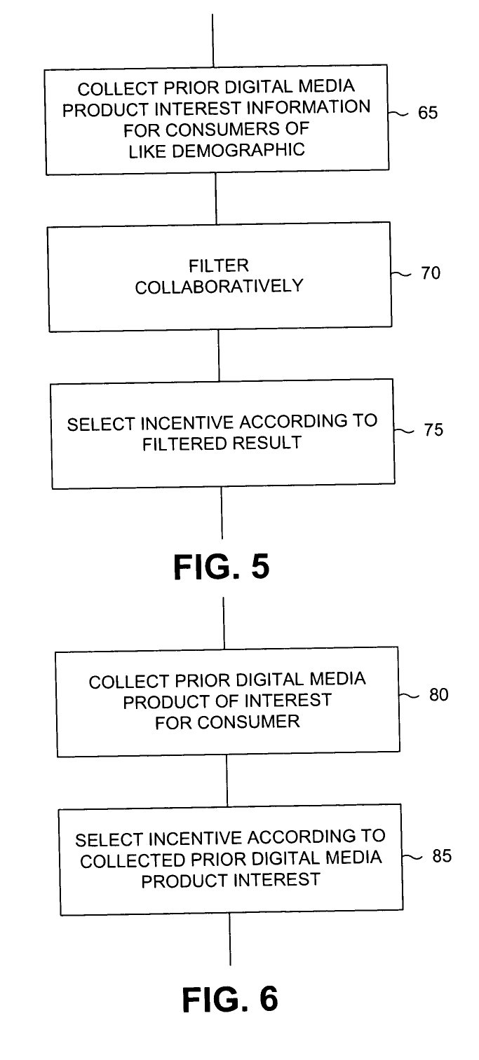

FIG. 5 is a flow diagram that depicts yet another alternative illustrative method for determining an incentive. According to this alternative illustrative method, a preference (or interest level) for a particular digital media product is collected from one or more other consumers that exhibit a demographic similar to a particular consumer (step 65). By applying a collaborative filter, also known as a social filter (step 70), a selection of an incentive (step 75) is made according to the filtered result. Any suitable collaborative filter may be applied in the selection process. For example, where a particular consumer exhibits a preference for a particular film-star, the selection of an incentive can be made using the prior selections made by other consumers that exhibit the same preference for that particular film-star. The use of collaborative filtering is well known in world-wide-web applications such as search engines wherein collaborative filtering is used to provide a selection of a web site.

FIG. 6 is a flow diagram that depicts yet another alternative method for determining an incentive. According to this alternative method, an incentive is determined by collecting prior digital media product interest for a particular consumer (step 80). According to one variation of the present method, interest in a particular digital media product is established when a consumer purchases the product. An incentive is then selected according to the collected prior digital media product interest (step 75). For example, a particular consumer they exhibit a preference for classical music. Accordingly, an incentive is selected from the genre of classical music.

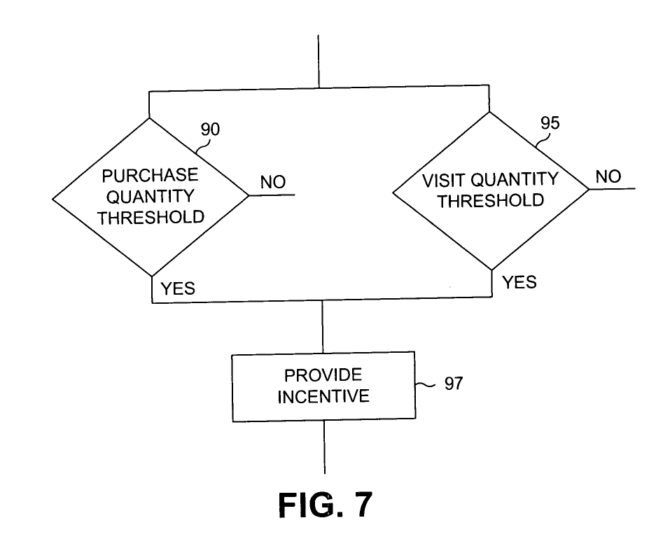

FIG. 7 is a flow diagram that depicts alternative methods for providing a determined incentive. According to one alternative illustrative method, an incentive is provided (step 97) when a consumer has purchased some quantitative of digital media product greater than a pre-established threshold (step 90). For example, an incentive, according to one alternative variation of the present method, is provided when a consumer has purchased at least one digital media product. It should be noted that this example is intended to illustrate the present method is not intended to limit scope of the claims appended hereto. The purchase level can be set to any appropriate threshold based on promotional objectives established by the provider of a digital media product. According to yet another alternative example method, the number of visits a consumer makes to a particular web site (step 95) is used as a basis for determining when an incentive is to be provided (step 97). Again, the threshold for the number of visits to a web site required before an incentive is provided can be established according to promotional objectives established by the provider of a digital media product.

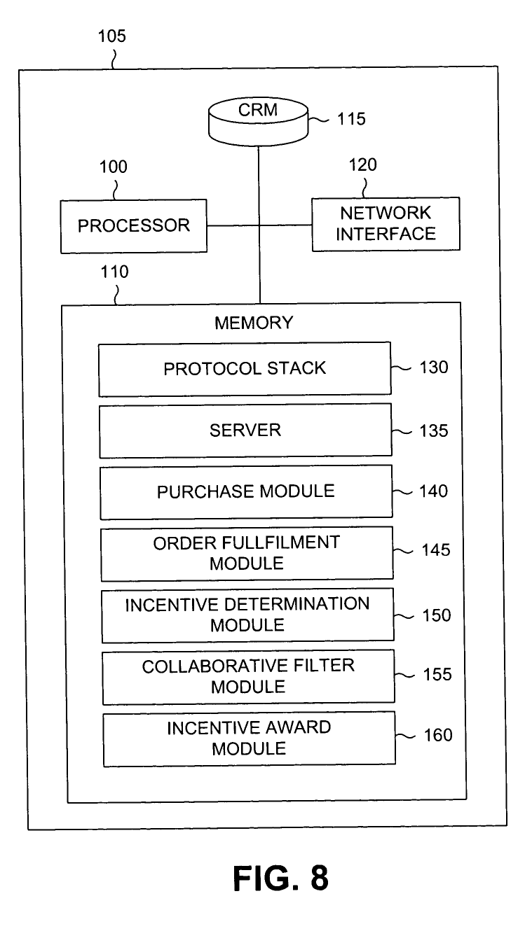

FIG. 8 is a block diagram of one example embodied of an apparatus for providing digital media product. According to this example embodied, an apparatus for providing digital media product 105 comprises one or more processors 100, a memory 110, a computer readable media 115 and a network interface 120. The afore listed features are communicatively coupled with each other by means of a bus 101.

Also included in this example embodiment of the apparatus 105 are one or more functional modules. A functional module is typically embodied as an instruction sequence. An instruction sequence that implements a functional module, according to one alternative embodiment, is stored in the memory 110. The reader is advised that the term “minimally causes the processor” and variants thereof is intended to serve as an open-ended enumeration of functions performed by the processor 100 as it executes a particular functional module (i.e. instruction sequence). As such, an embodiment where a particular functional module causes the processor 100 to perform functions in addition to those defined in the appended claims is to be included in the scope of the claims appended hereto. Included in this example embodiment of an apparatus for distributing a digital media product 105 are a purchase module 140, an incentive determination module 150 and an incentive award module 160, all of which are stored in the memory 110. This example embodiment further includes a protocol stack module 130 and a server module 135, both of which are stored in the memory 110. According to one alternative embodiment, an order fulfillment module 145 is also included and stored in the memory 110. According to yet another alternative embodiment, a collaborative filter module 155 is also included and is stored in the memory 110.

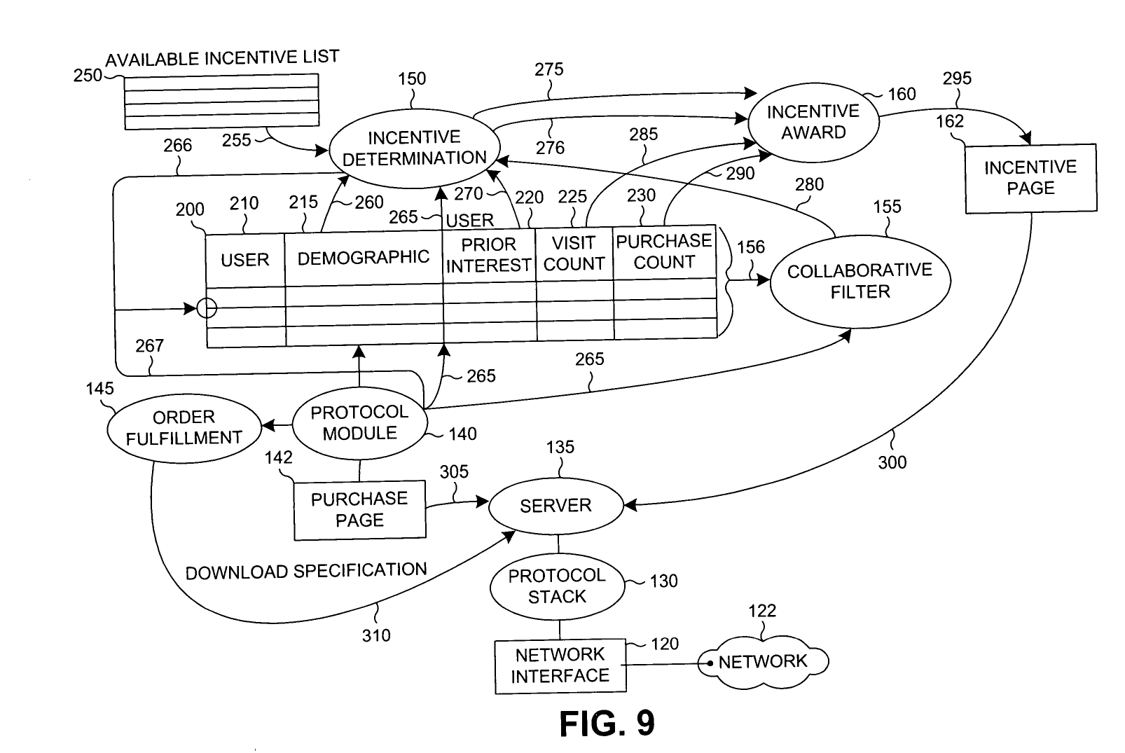

FIG. 9 is a data flow diagram that depicts the internal operation of one example embodiment of a digital media product distribution system. A processor 100 included in this example embodiment of a digital media product distribution system executes a server module 135. The server module 135, when executed by the processor 100, minimally causes the processor 100 to interact with a protocol stack module 130. Collectively, the server module 135 and protocol stack module 130, when executed by the processor 100, enable the processor 100 to receive a request for a web page by means of the network interface 120. The server module 135 and protocol stack module 130, when executed by the processor 100, further minimally enable the processor 100 to direct to a web page definition stored in the computer readable media and 115 to a network interface 120. According to one alternative embodiment, this is accomplished with the processor 100 executes the server module 135. By executing the server module 135, the processor 100 is minimally caused to retrieve a web page definition stored in the computer readable media 115. The server module 135 further minimally causes the processor 100 to direct the web page definition to a protocol stack module 130. In turn, the protocol stack module 130, when executed by the processor 100, further minimally causes the processor 100 to communicate with the network interface 120 using a protocol stack definition (e.g. transfer control protocol/internet protocol). It should be noted that the network interface 120 is communicatively coupled with a network 122.

According to one illustrative use case, a request for a purchase page 142 is received by way of the network interface 120. In response to this request, the processor 100, as it continues to execute the server module 135, minimally retrieves the purchase page 142 from the computer readable media 115 and directs the purchase page 142 to the network 122 using the mechanism heretofore described. A typical purchase page 142 provides a graphical user interface that supports the purchase of a digital media product by a consumer.

According to one alternative embodiment, the purchase page 142 has associated therewith a purchase module 140 that is executed by the processor 100 substantially contemporaneously with the conveyance of the purchase page 142 to the network 122. It should be noted that conveyance to the network 122 of any web page definition, as described herein, is accomplished when the processor 100 executes the server module 135 in conjunction with the protocol stack module 130. The purchase module 140, when executed by the processor 100, minimally causes the processor to provide a first digital media product to the consumer. According to one illustrative embodiment, the purchase module 140 further minimally causes the processor 100 to identify a particular consumer by means of the user number. The user number is conveyed 265 to the incentive determination module 150 included in this example embodiment of an apparatus for distributing a digital media product. The purchase module 140, according to one alternative embodiment, is augmented by an order fulfillment module 145. The order fulfillment module 145, when executed by the processor 100, minimally causes the processor to direct a download specification 310 to the network interface 120 as one means for enabling a consumer to obtain a digital media product.

The incentive determination module 150, when executed by the processor 100, minimally causes the processor to determine an incentive according to a preference exhibited by the consumer. Accordingly, the incentive determination module 150 identifies a particular consumer by means of a user number provided 265 by the purchase module 140. Further included in this embodiment is an incentive award module 160. The incentive award module 160, when executed by the processor 100, minimally causes the processor 100 to provide a determined incentive when the consumer has satisfied an incentive threshold. The incentive determination module 150 further minimally causes the processor 100 to provide a determined incentive 275 to the incentive award module 160. The incentive determination module 150 also provides a user number 276 to the incentive award module 160. It should be noted that according to one alternative embodiment, the incentive determination module 150 minimally causes the processor 100 to determine an incentive by minimally causes the processor to select an incentive from at least one of a second digital media product, a concert ticket, a movie ticket, a fan merchandise and a promotional coupon according to the teachings of the present method.

According to one alternative illustrative embodiment, the incentive determination module 150, when executed by the processor 100, causes the processor 100 to determine an incentive by minimally causing the processor 100 to provide a consumer a list of available incentives and subsequently receive a selection of one or more of the available incentives from the consumer. According to yet another alternative illustrative embodiment, the incentive determination module 150, when executed by the processor 100, minimally causes the processor 100 to create an incentive web page according to a list of available incentives 250. The incentive web page is direct and to the network 122 when the processor 100 continues to execute the server module 135 in conjunction with the protocol stack module 130. The processor 100 further receives a user selection from the network interface 120 through continued execution of the server module 135 and protocol stack module 130.

According to yet another alternative example embodiment, the incentive determination module 150, when executed by the processor 100, causes the processor to determine an incentive by minimally causing the processor 100 to determine an incentive according to a demographic collected by the processor 100 as it executes the purchase module 140. According to this example embodiment, the purchase module 140 further minimally causes the processor to collect a demographic pertaining to the consumer. In one derivative embodiment, the purchase module 140 further minimally causes the processor to store the demographic in a user table 200. Accordingly, the processor 100 will store the demographic in a user record selected according to a user number 267. Once the record is selected, the demographic is stored in a demographic field 215 included in the user table 200. The incentive determination module 150 of this derivative example embodiment retrieves the collected demographic from the user table 200 according to the user number 266. According to one alternative embodiment, a demographic includes but is not necessarily limited to at least one of a gender for the consumer, an age for the consumer, an income bracket for the consumer, marital status for the consumer, number of children for the consumer, an occupation indicator for the consumer, a favorite recording artist, a favorite film-star and a favorite pastime.

According to yet another alternative embodiment wherein the purchase module 140 further minimally causes the processor 100 to collect a demographic for a particular consumer, the incentive determination module 150 minimally causes the processor 100 to execute a collaborative filter module 155. The collaborative filter module 155 is included in this alternative embodiment. When executed by the processor 100, the collaborative filter module 155 minimally causes the processor 100 to identify one or more other consumers that exhibit a similar demographic to a particular consumer. A particular consumer is identified by a user number 265 provided by the purchase module 140. According to one derivative embodiment, the collaborative filter module 155 minimally causes the processor 100 to retrieve 156 a demographic from a user table 200 that includes a demographic field 215 and that is indexed according to a user number 210. As such, a demographic is retrieved 156 for one or more other consumers wherein the demographic satisfies a comparison with a demographic for a particular user identified by a user number 265. The collaborative filter module 155 further minimally causes the processor to apply a collaborative filter process, which is a well-known technique, to preferences exhibited by the one or more other consumers. Typically, this is accomplished by retrieving a prior interest indicator for the user table 200 stored in a prior interest field 220 in each user record maintained in the user table 200. The processor 100, as it continues to execute the collaborative filter module 155, determines an incentive according to the collaboratively filtered preferences exhibited by the one or more other users. The determined incentive is then provided 280 to the incentive determination module 150.

According to yet another alternative example embodiment, the incentive determination module 150, when executed by the processor 100, causes the processor to determine an incentive by minimally causing the processor 100 to determine an incentive according to a prior digital media product interest collected by the processor 100 as it executes the purchase module 140. According to this example embodiment, the purchase module 140 further minimally causes the processor to collect a digital media product interest pertaining to the consumer. In one derivative embodiment, the purchase module 140 further minimally causes the processor to store the digital media product interest in a user table 200. Accordingly, the processor 100 will store the digital media product interest in a user record selected according to a user number 267. Once the record is selected, the digital media product interest is stored in a prior interest field 215 included in the user table 200. The incentive determination module 150 of this derivative example embodiment retrieves the collected digital media product interest from the user table 200 according to the user number 266. According to one alternative embodiment, a digital media product interest includes but is not necessarily limited to at least a prior purchase of a digital media product.

According to one alternative embodiment, the incentive award module 160 causes the processor to provide an incentive when a consumer has purchased some quantity of digital media product. In this alternative embodiment, the purchase module 140 further minimally causes the processor to maintain a count of purchase digital media products for a particular user. According to one derivative embodiment, the purchase module 140 minimally causes the processor 100 to maintain a purchase count in a purchase count field 230 included in a user record stored in a user table 200. A particular record in the user table 200 is selected according to a user number 267 provided by the purchase module 140. The user number is stored in a user number field 210 included in each record stored in the user table 200. The incentive award module 160 of this alternative embodiment further minimally causes the processor 100 to retrieve from the user table 200 a purchase count from the purchase count field 230 according to the user number stored in a user number field 210. When the processor 100 determines that a particular user has met or exceeded a pre-established threshold for a count of purchase to digital media products, the processor 100, as it continues to execute the incentive award module 160, further minimally generates an incentive page 162 that is directed 300 to the server module 135. Typically, the incentive page 162 is fashioned to describe a particular incentive and to notify a consumer that the described incentive has been awarded. The incentive page 162 can also included information enabling the consumer to obtain an awarded incentive.

According to one alternative embodiment, the incentive award module 160 causes the processor to provide an incentive based on how many times a consumer has visited a particular web site. In this alternative embodiment, the purchase module 140 further minimally causes the processor to maintain a count of web site visits for a particular user. According to one derivative embodiment, the purchase module 140 minimally causes the processor 100 to maintain a web site visits count in a visit count field 225 included in a user record stored in a user table 200. A particular record in the user table 200 is selected according to a user number 267 provided by the purchase module 140. The user number is stored in a user number field 210 included in each record stored in the user table 200. The incentive award module 160 of this alternative embodiment further minimally causes the processor 100 to retrieve from the user table 200 a web site visits count from the visit count field 225 according to the user number stored in a user number field 210. When the processor 100 determines that a particular user has met or exceeded a pre-established threshold for a count of web site visits, the processor 100, as it continues to execute the incentive award module 160, further minimally generates an incentive page 162 that is directed 300 to the server module 135. Typically, the incentive page 162 is fashioned to describe a particular incentive and to notify a consumer that the described incentive has been awarded. The incentive page 162 can also included information enabling the consumer to obtain an awarded incentive.

The functional modules (i.e. their corresponding instruction sequences) described thus far that enable distribution of a digital media product according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert a general-purpose computing platform into a device capable of distributing a digital media product according to the techniques and teachings presented herein. Accordingly, the claims appended hereto are to include such computer readable medium imparted with such instruction sequences that enable execution of the present method and all of the teachings herein described.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. A method for providing content comprising:
providing a first digital media product to a consumer;
determining an incentive according to a preference exhibited by the consumer; and
providing the determined incentive when the consumer has satisfied an incentive threshold.

2. The method of claim 1 wherein determining an incentive comprises selecting as an incentive at least one of a second digital media product, a concert ticket, a movie ticket, a fan merchandise and a promotional coupon.

3. The method of claim 1 wherein determining an incentive comprises:
presenting to the consumer an enumeration of available incentives; and
receiving from the consumer a selection of one or more of the enumerated available incentives.

4. The method of claim 1 wherein determining an incentive comprises:
collecting demographic information pertaining to the consumer; and
selecting an incentive according to the demographic.

5. The method of claim 1 wherein determining an incentive comprises:
collecting prior digital media product interest information from one or more other consumers exhibiting demographic similar to the consumer;
collaboratively filtering the collected prior content interest information; and
selecting an incentive according to a collaboratively filtered result.

6. The method of claim 1 wherein determining an incentive comprises:
collecting prior digital media product interest information for the consumer; and
selecting an incentive according to the collected prior digital media product interest information.

7. The method of claim 1 wherein providing the determined incentive when the consumer has satisfied an incentive threshold comprises at least one of providing the determined incentive when the consumer has purchased a quantity of digital media products in excess of a pre-established value and providing the determined incentive when the consumer has visited a web site in excess of a pre-established value.

8. A digital media product distribution system comprising:
processor for executing instructions;
memory for storing one or more instruction sequences;
computer readable medium for storing a web page definition and user information;
network interface for communicating with a communications network; and
instruction sequences modules stored in the memory including:
protocol stack module that, when executed by the processor, minimally causes the processor to communicate with a network using the network interface;
server module that, when executed by the processor, minimally causes the processor, in response to a request received from the network, to direct to the protocol stack a web page definition stored in the computer readable medium;
purchase module that, when executed by the processor, minimally causes the processor to provide a first digital media product to a consumer;
incentive determination module that, when executed by the processor, minimally causes the processor to determine an incentive according to a preference exhibited by the consumer; and
incentive award module that, when executed by the processor, minimally causes the processor to provide a determined incentive when the consumer has satisfied an incentive threshold.

9. The digital media distribution system of claim 8 wherein the incentive determination module causes the processor to determine an incentive by minimally causing the processor to select an incentive from at least one of a second digital media product, a concert ticket, a movie ticket, a fan merchandise and a promotional coupon.

10. The digital media distribution system of claim 8 wherein the incentive determination module causes the processor to determine an incentive by minimally causing the processor to:
create an incentive web page according to a list of one or more available incentives;
direct the incentive web page to the network interface by executing the server module and the protocol stack module; and
receive a user selection from the network interface by continues execution of the server module and the protocol stack module.

11. The digital media distribution system of claim 8 wherein the purchase module further minimally causes the processor to collect a demographic pertaining to the consumer and wherein the incentive determination module causes the processor to determine an incentive by minimally causing the processor to select an incentive according to the collected demographic.

12. The digital media distribution system of claim 8 wherein the purchase module further minimally causes the processor to collect a demographic pertaining to one or more other consumers and further comprising a collaborative filer module that, when executed by the processor, minimally causes the processor to:
identify one or more of the other consumers as having a similar demographic to the consumer;
perform a collaborative filter process according to a preference exhibited by the identified other consumers; and
determine an incentive according to the collaboratively filtered preference and wherein the incentive determination module causes the processor to determine an incentive by minimally causing the processor to execute the collaborative filter module.

13. The digital media distribution system of claim 8 wherein the purchase module further minimally causes the processor to collect prior digital media product interest pertaining to the consumer and wherein the incentive determination module causes the processor to determine an incentive by minimally causing the processor to select an incentive according to the collected prior digital media product interest.

14. The digital media distribution system of claim 8 wherein the purchase module further minimally causes the processor to maintain a count of purchased digital media products for the consumer and wherein the incentive award module causes the processor to provide an incentive when the consumer count of purchased digital media reaches or exceeds a pre-established threshold.

15. The digital media distribution system of claim 8 wherein the purchase module further minimally causes the processor to maintain a count of visits to a web site for the consumer and wherein the incentive award module causes the processor to provide an incentive when the consumer count of web site visits reaches or exceeds a pre-established threshold.

16. A computer readable medium having imparted thereon one or more instruction sequences for enabling distribution of a digital media product including:
purchase module that, when executed by the processor, minimally causes a processor to provide a first digital media product to a consumer;
incentive determination module that, when executed by a processor, minimally causes the processor to determine an incentive according to a preference exhibited by the consumer; and
incentive award module that, when executed by a processor, minimally causes the processor to provide a determined incentive when the consumer has satisfied an incentive threshold.

17. The computer readable medium of claim 16 wherein the incentive determination module causes a processor to determine an incentive by minimally causing the processor to select an incentive from at least one of a second digital media product, a concert ticket, a movie ticket, a fan merchandise and a promotional coupon.

18. The computer readable medium system of claim 16 wherein the incentive determination module causes a processor to determine an incentive by minimally causing the processor to:
create an incentive web page according to a list of one or more available incentives;
direct the incentive web page to a network interface by executing a server module and a protocol stack module; and
receive a user selection from the network interface by continued execution of the server module and the protocol stack module.

19. The computer readable medium system of claim 16 wherein the purchase module further minimally causes a processor to collect a demographic pertaining to the consumer and wherein the incentive determination module causes a processor to determine an incentive by minimally causing the processor to select an incentive according to the collected demographic.

20. The computer readable medium system of claim 16 wherein the purchase module further minimally causes a processor to collect a demographic pertaining to one or more other consumers and further comprising a collaborative filer module that, when executed by a processor, minimally causes the processor to:
identify one or more of the other consumers as having a similar demographic to the consumer;
perform a collaborative filter process according to a preference exhibited by the identified other consumers; and
determine an incentive according to the collaboratively filtered preference and wherein the incentive determination module causes the processor to determine an incentive by minimally causing the processor to execute the collaborative filter module.

21. The computer readable medium system of claim 16 wherein the purchase module further minimally causes a processor to collect prior digital media product interest pertaining to the consumer and wherein the incentive determination module causes the processor to determine an incentive by minimally causing the processor to select an incentive according to the collected prior digital media product interest.

22. The computer readable medium system of claim 16 wherein the purchase module further minimally causes a processor to maintain a count of purchased digital media products for the consumer and wherein the incentive award module causes a processor to provide an incentive when the consumer count of purchased digital media reaches or exceeds a pre-established threshold.

23. The computer readable medium system of claim 16 wherein the purchase module further minimally causes a processor to maintain a count of visits to a web site for the consumer and wherein the incentive award module causes a processor to provide an incentive when the consumer count of web site visits reaches or exceeds a pre-established threshold.
